(19) United States
(12) Patent Application Publication
(10) Pub. No.: US 2024/0326353 A1
(43) Pub. Date: Oct. 3, 2024

(54) A Dynamic Configurable Digital Mold

(71) Applicant: Massivit 3D Printing Technologies Ltd., Lod (IL)

(72) Inventor: Yehoshua Sheinman, Ra'anana (IL)

(21) Appl. No.: 18/713,731

(22) PCT Filed: Mar. 3, 2022
(86) PCT No.: PCT/IL2022/050242

§ 371 Date: May 28, 2024

(51) Int. Cl. B29C 70/42; B29K 105/08

(52) U.S. Cl. CPC B29C 70/42; B29K 2105/0845

(57) ABSTRACT

Described is a method for manufacturing 3D objects from woven fabric-based composite materials. The method includes a movable mold used to manufacture a complete object by tiling the object, instead of using a single monolithic mold. The method includes using an easily configurable digital mold matrix for the tiling mentioned above and a calibration unit configured to set the desired shape of a strip of the digital mold matrix surface. A digital file provides the information required for building the digital mold surface. A movable and adjustable pins matrix form a configurable support surface of the digital mold matrix. The configurable support surface of the digital mold matrix receives and supports the material from which the 3D object is built while tiling.

### TECHNOLOGY FIELD

The apparatus and method relate to mold manufacturing, particularly a configurable digital mold.

### BACKGROUND

The additive manufacturing technology (a.k.a. three-dimensional (3D) printing) is rapidly expanding, attracting interest, and developing new, improved materials and higher performing automated machines used to form any desired tridimensional shape. There is also a growing interest in expanding the formed parts' size.

One production branch that is not sufficiently treated in the 3D printing field is the thin “skin-like” envelope parts made from composite fabric and resins materials. The skin-like parts are produced currently using prepared ahead of time mold. The fabric is layered manually or automatically and impregnated by resin; another option relates to the use of pre-impregnated fabrics.

Additive manufacturing equipment uses a layer-based manufacturing process to build any desired tridimensional part. It creates functional 3D parts or objects by extruding, dispensing, or jetting deposition, layer after layer, complex three-dimensional objects. The part or 3D object fabrication machinery receives data directly from a computer-aided design (CAD) system.

Each new layer is deposited on top of the previous one and has a cross-section, size, and shape that depends on several parameters: material type, material temperature, dispenser output flow, machine feeding rate, and several others. The multiple layer building process aims to produce 3D objects or parts that must be ultimately stable in shape and meet a desired strength and durability.

The existing 3D printers are handling composite materials that contain resin (thermoplastic or thermoset) and fibers (glass, carbon, and others). The fibers could be chopped fibers or continuous extruded fibers materials. On the other hand, the existing printers cannot handle composite materials using a woven fabric, like the envelope parts described above. In additive manufacturing, the fibers are aligned with the cartesian axes of the printer. In contrast, in composite envelope parts, the fibers are aligned in the local envelope plane resulting in maximum strength benefits. Similar to 3D printing, objects made from these materials are built using layers. In the 3D printing case, the layers generate the product shape. In the fabric-based composites—each layer is a building brick that increases the material thickness but does not necessarily affect the shape. The resin bonds the fabric layers into a single matrix of fabric and resin. The mold that accepts the layers shapes the fabricated part. Several 3D printers and processes are used for the digital manufacture of the mold, but the mold remains a necessary expensive element in the processing of fabric-based composites.

The required mold is getting more expensive and complex as the size of the product grows. Currently, the largest composite parts or products produced using woven fabric and resin are wind turbine blades. The blades are long (several tens of meters) and narrow (several meters).

The cost of the mold prevents any variation in the product or product “personalization” although product personalization provides a significant advantage.

### Definitions

As used in the current disclosure, the term “Digital Mold (DM)” relates to an easily configurable curved surface, computer-controlled mold for use in the layup of prepreg woven fabric layers for three-dimensional object manufacturing.

The term “mold also mould” relates to a cavity or prominence in which a substance, for example, a plastic or a 3D object material that the cavity or prominence shapes is deposited.

The term “skin” or “skin-like” means a layer of material that forms the most external layer of a printed part or a three-dimensional object whose shape is mainly configured by its outer surfaces rather than its internal surfaces.

The term “stroke amplifier” means an intermediate mechanical element that increases the magnitude of an input signal. The stroke amplifier amplifies the mechanical input to enhance the mechanical signal output from a given source.

The term “matrix pin calibration station” means a device that affects the shape of the configurable support surface.

The term “pushing finger” means a movable rod configured to push (activate) free matrix pins of the matrix pin calibration station.

The term “digital mold unit” means a separate unit including a single array of configurable free pins sector of a digital mold unit. Upon completion of the digital mold unit calibration, the unit transfers the calibrated shape to a line of movable pins of the digital mold matrix.

### SUMMARY

Described is a method and apparatus for manufacturing 3D objects from woven fabric-based composite materials. The method includes using an easily configurable movable and adjustable matrix of pins organized in rows and columns that form a configurable support surface of the digital mold matrix. A common enclosure contains all of the movable and adjustable pins of the matrix. The movable and adjustable matrix pins are passive pins without a dedicated activation and control. All movable and adjustable matrix pins activation and control are external to the matrix pins' enclosure. Such an arrangement of passive pins supports the high packaging density of the matrix pins.

An external matrix pins calibration unit is operative to set a desired shape of the configurable digital mold matrix surface. The calibration unit includes a stationary frame and a crossbar. A linear matrix (array) of movable pins is mounted on the crossbar. A pushing “finger” traveling along the linear matrix of movable pins pushes selected movable pins and sets the length and shape of the array of matrix pins. The shape is transferred to a row of pins of the configurable movable and adjustable matrix of pins. The shape of the array of matrix pins matches at least the shape of a row/line of the manufactured object. The row of the shaped pins of the matrix is locked and maintains its shape.

The configurable support surface of the digital mold matrix receives and supports the material from which the 3D object is built. The material is deposited in the form of the 3D object material tiles instead of a single monolithic material layer. A computer provides the information required for building the digital mold surface and assists in dividing a large curved surface into a plurality of tiles. Upon completion of a tile deposition, a computer delivers the next tile to be produced. The calibration unit sets the next tile desired shape. The digital mold matrix surface is repositioned to deposit the next tile accounts for an overlap between the tiles. The overlap facilitates the attachment of the next tile to the previously deposited tile and enhances the strength of the 3D object.

### LIST OF DRAWINGS AND THEIR SHORT DESCRIPTION

To better understand the apparatus and method and see how it could be carried out in practice, examples will now be described, by way of non-limiting example only, with reference to the accompanying drawings, in which identical referral numbers mean identical or similar parts. In the drawings:

FIG. 1 is an example of a typical digital matrix pins assembly, implemented according to the passive control concept of FIG. 2;

FIG. 2 is an example illustrating an option for a single-passive pin and a mechanism for moving the passive pin and allowing passive position control;

FIG. 3A is an example of a mechanism for locking lines of matrix pins;

FIG. 3B is an example of the matrix pin locking mechanism;

FIG. 3C illustrates the kinematics of a matrix pin locking process;

FIG. 4A is a cross-section of an example of a flexible elastomeric strip suitable for use for the digital matrix layering surface;

FIG. 4B is another cross-section of an example of a flexible elastomeric strip assembled on the pins of the digital mold matrix pins;

FIG. 4C illustrates how the flexible elastomeric strip is mounted on a group or line of matrix pins;

FIG. 5 is an example of the way the flexible elastomeric strip is mounted on a group or line of matrix pins and supported from both sides using the frame of the matrix pins;

FIG. 6 is an example of the matrix pin calibration station;

FIG. 7A is an example of the free pin mechanism of the pin calibration system;

FIG. 7B is an example of the braking mechanism of the free pin mechanism of the pin calibration system;

FIG. 8A is an example of a basic layout of a digital mold assembly set-up of an apparatus for layering a woven fabric material; having a single calibration system;

FIG. 8B is an example of a basic layout of an apparatus for layering a woven fabric material and the set-up of a digital mold assembly with two calibration systems;

FIG. 9A is an example of a large cylindrical part to be manufactured using the present apparatus and method;

FIG. 9B is an example of a relative stroke of a matrix pin in the digital mold matrix;

FIG. 9C is an example of digital mold assembly supporting a linear movement of the digital mold in one movement axis and two angular rotation directions;

FIG. 9D is an example of digital mold assembly supporting the movement of the digital mold in three angular rotation directions, using a standard robotic arm;

FIG. 9E illustrates the length of the matrix pin stroke of the digital mold matrix as compared to a matrix pin stroke required for a circle with a radius of 3 meters;

FIG. 10(a) is an example of a typical prepreg layup by tiling that supports overlapping of the built part between adjacent digital mold matrix stations;

FIG. 10(b) presents the regular prepreg layup by tiling that supports overlapping of the built layers between adjacent digital mold matrix stations;

FIG. 10(c) is an example of an optimal tiling situation where the accuracy of the layering is sufficiently high;

FIG. 10(d) is an example of over-tiling of the deposited material layers;

FIG. 10(e) is an example of under-tiling of the deposited material layers;

FIG. 11 is an example of a side frame for additional process steps after the manufacturing the inner side of the machine, which is, external of the manufactured part envelope;

FIG. 12 is an example of the pin arrangement and the digital mold inclination facilitating the manufacturing of the side frame;

FIG. 13A is a schematic illustration of the support process of the first line of tiles of the woven fabric composite product; while the last tile is still in layup mode;

FIG. 13B is a schematic illustration of the support of the built tiles from the second and higher order lines of tiles;

FIG. 13C is an example of a vacuum anchoring unit;

FIG. 14 is a schematic illustration of the two bridges that carry the vacuum anchoring units;

FIG. 15A illustrates additional details of the bottom support 1316 of FIG. 13;

FIG. 15B is a schematic description of the “stepping forward” process, using the top anchoring units and the bottom support; and

FIG. 16 is an example of platform that supports the finished elongated 3D object and allows its removal from the building machine.

### DESCRIPTION

As noted, the manufacture of some 3D objects requires molds. The mold that accepts the material layers configures the shape of the manufactured part or 3D object. Once the mold is generated, it cannot be changed or adapted to manufacture a different part or object. The manufacture of even slightly different 3D objects requires a different shaped mold. Although some methods for digitally manufacturing a mold exist, they do not cancel the need for a mold.

As the size and the complexity of the 3D object grows, the mold is getting more expensive. Currently, the largest composite parts that are produced using woven fabric and resin are wind turbine blades. The blades are long (several tens of meters) and narrow (several meters). The required mold is expensive, and its production is complex too.

It is natural that efforts to simplify mold production exist and continue. United States U.S. Pat. Nos. 4,536,980; 5,796,620; 6,189,246; 6,903,871, and 11,001,016 disclose some types of reconfigurable molds. The patents disclose using a pinscreen concept where a matrix of retractable pins serves as a bed receiving the 3D object. To produce a smooth surface required by the mold, the density of the pins becomes high and significantly increases the mold cost.

The U.S. Pat. No. 6,903,871 patent produces a three-dimensional surface from a sheet of elastic material covering a matrix of control rods. A computer-controlled system determines the position of each of the rods. Each rod is fitted with two pneumatically controlled locking mechanisms, one for the X coordinate and one for the Y coordinate. When both locks on a particular rod are released, the rod is free to move to a new position determined by an elevator. Once all rods have been adjusted they are locked in position, and the surface has been configured.

The U.S. Pat. No. 11,001,016 patent forms a smooth surface using a reconfigurable polymer mold. An array of actuated pins may deform the polymer mold into a desired 3D shape. The composite material may be inside a cavity formed by the mold and a flexible bag. A vacuum pump may remove air from the cavity, creating a partial vacuum. The partial vacuum may cause the flexible bag to press the composite tightly against the mold to conform to the desired 3D shape. One or more heating elements may be embedded in the mold and heat the composite to cure the composite.

The apparatuses described in the mentioned patents and others lack several properties that limit or even eliminate their use as a traditional mold replacement for woven fabric-based composites.
1. The resolution of the 3D surface presented by the pins depends on the pins' density, i.e., how many pins could be packed in a certain area. Typical mold requires a distance between pins of 0.5-1% of the representative dimension. For example, in the case of large-size products, with a representative dimension of one meter or more, this distance between the pins is between 5-10 mm. Such distance is too small for packing the motors, the gears, and the brakes, required for the independent position change and control of each pin.
2. To achieve the required resolution using pins, 10,000 to 40,000 pins per square meter are required. A large number of pins will lead to extremely expensive apparatus, which will not be economical for large woven fabric-based composite products.
3. The assignment of woven fabric layers on an open mold requires external pressure to fully attach the fabric layers to the mold to reduce the trapped air cavities and the material porosity. The pressure can be applied using vacuum (vacuum bag system), or by an external pressing roller (using similar to AFP [Automatic Fabric Placement] type device); both methods are standard in the composite material production field. In both approaches, external, non-negligible in magnitude force is applied axially on each pin. To support the required surface variability, a long pin stroke is required. Typical strokes can reach 80 cm and more. Due to mechanical design aspects, the required actual pin length is even longer. As the pins are thin and long (starting from 5-10 mm in diameter and more than 800 mm in length), any axial force can lead to bending, position loss, and even buckling. Shorter stroke values can overcome this problem, but the usability of the apparatus in large-size product manufacturing will be insignificant.
4. The suggested use of a single flexible membrane (including a slidable connection to the pin edge, magnetic attachment, or other forces) as a mold surface cannot be used easily for complex surfaces and high pin stroke. In large size composite products, even the initial dimensions of the membrane could be large. The required curved surface dimensions of the membrane could be much larger than the initial dimensions of the membrane (measured when all the pins are in the same stroke value) in a factor of 2 and more. The curved surface requires an ability to stretch the membrane back to position when the system was initialized and let it move to the position while arranging the new surface condition. This makes the membrane stretching and stretch release operation complex.

These aspects and others indicate that the use of pin screens as described in the literature and the prior arts limits the case of digital mold manufacture for large woven fabric-based composite products.

Neither one of the listed references suggests or motivates the pre-shaped mold solutions to woven fabric-based composite materials. The present disclosure provides an apparatus and method that eliminates pre-shaped mold to manufacture woven fabric-based composite products. The disclosure suggests using the pinscreen as a digital mold for manufacturing woven fabric-based composite objects.

The present disclosure also suggests a calibration unit to shape the pinscreen as a digital mold for manufacturing woven fabric-based composite objects.

The present disclosure further suggests a method and apparatus for manufacturing elongated composite 3D objects, mainly woven fabric-based composite elongated objects.

One of the problems of the referenced patents is that the pins or rods activation and control are located inside their enclosures, reducing the availability of the space for movable pins drive and position control and limiting the ability to decrease the distance between the pins and increase the pin-screen resolution.

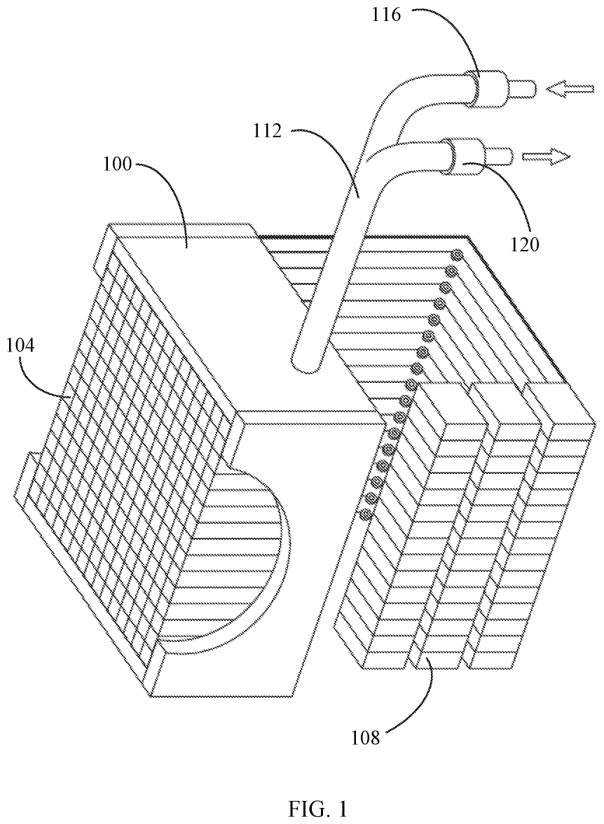

FIG. 1 is an example of the present configurable digital mold matrix assembly. A digital mold matrix assembly enclosure 100 or simply enclosure includes a plurality of movable matrix pins 104 organized in rows and columns. Pins 104 could be moved along their longitudinal axis. Illustrated in FIG. 1 is also stroke amplifies 108. The stroke amplifiers do not reside in a digital mold matrix assembly enclosure 100 and are external to the digital matrix pins assembly enclosure 100. This arrangement allows a high density of the pins 104 as the stroke amplifiers consume no additional volume inside the matrix enclosure like in the referenced disclosures.

An air hose 112 connects the digital mold matrix enclosure 100 through high pass pressure valve 116 and a high flow vacuum valve 120 with a high-pressure/high flow blower (not shown) and a low vacuum/high flow aspirator (not shown).

The airflow system is in use in the 3D object (or part) building process, and its operation will be described below. The digital matrix pins 104 are passive pins. Each matrix pin 104 has no built-in activation and no internal position measurement sensors. All matrix pins 104 activations and internal position measurement sensors are located outside (external to) digital mold matrix enclosure 100, supporting dense movable matrix pins 104 packagings. An external calibration unit adjusts and sets the position of digital matrix pins 104.

One of the drawbacks of the pinscreens disclosed in the above references is the relatively low resolution is due to the need to drive or move each pin separately (by a motor drive for each pin). Such motor drive consumes space, reduces density/resolution, and increases the cost. The present disclosure offers a method and apparatus supporting the ability to drive each pin separately without requiring motor drive use per every pin.

The higher the required resolution is, the lower is the available volume per pin. The high-resolution available volume per pin does not support the packing of motors and gears in the volume of enclosure 100. The available volume of enclosure 100 does not support switching of a large amount of high current clients for operating the matrix pin 104 motion and measuring each pin 104 location, i.e., to implement a close control loop on the location of each pin. Furthermore, all this equipment should withstand external forces associated with the woven fabric layering process in the course of which the layers add weight and become heavy. The high weight of the digital mold matrix influences the design of the digital mold matrix assembly and might increase its cost.

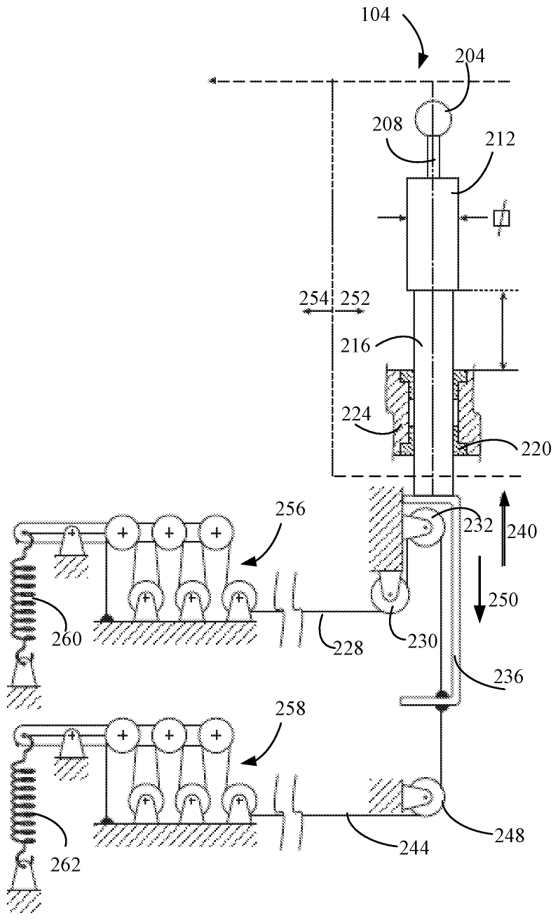

FIG. 2 is an example illustrating the operation of a single-passive pin (i.e., pin that is operated without having a specific motor drive) of the digital mold matrix and a mechanism for moving the passive pin and supporting pin position control. Digital mold matrix pin 104 is subject to constant not-equal forces, applied on both sides/ends of matrix pin 104. The difference between the applied to individual pin forces facilitates passive matrix pin 104 movement and position control. Each matrix pin 104 includes several elements: a ball-shaped edge 204, a cylindrical neck 208, a matrix pin body 212 with a rectangular cross-section, a cylindrical shaft 216, and a linear bearing 220. When side forces are applied on a single matrix pin 104, the flat side (of the rectangular cross-section) could transfer the forces to the adjacent digital mold matrix pins 104 surrounding it and thus reduce the bending force reaction. The square sides leaning on the surrounding matrix pins reduce the shear force applied on a linear bearing 220 guiding matrix pin 104. Linear bearing 220 assembled in the digital mold matrix main plate 224.

Linear bearings 220 facilitate cylindrical shaft 216 linear motion to a specific stroke length L. A top tensioning cable 228 is threaded through two stationary pulleys 230 and 232 and connected to a cable mount 236. Pulling of cable 228 forces matrix pin 104 to move in the direction of arrow 240 or up wise. A bottom tensioning cable 244 is threaded through the stationary pulleys 248 and connected to cable mount 236. Pulling the bottom cable forces the matrix pin 104 to move in the direction of arrow 250 or go down-wise.

Both cables 226) and 244 are external to matrix enclosure 100. Both cables 228 and 244 moving digital matrix pin 104 do not reside or share the same volume with the digital matrix pins 104 and digital matrix enclosure volume 252. Volume 254 is large and has ample space to accommodate stroke amplifiers 256 and 258 and cables 228 and 244.

The top cable 228 is connected to a pulley-based “stroke amplifier” 256, and the bottom cable 244 is connected to a pulley-based stroke amplifier 258 too. All types of stroke amplifiers convert small displacement of the spring edge into high variation in the stroke/position of the pin, and different types of stroke amplifiers could be used. The force that pushes the pin upwards (in the presented example) is proportional to K1−K2, where K1 is the spring constant of the stroke amplifier 256, and K2 is the spring constant of the stroke amplifier 258. The stroke amplifiers could be packed in density similar to the pins 104 density, supporting the entire assembly a better and more compact packaging.

The stroke amplifiers 256 and 258 are also external to the matrix enclosure. The arrangement of the stroke amplifier stack is external to matrix enclosure 100 and does not consume an additional volume of enclosure 100 (FIG. 1).

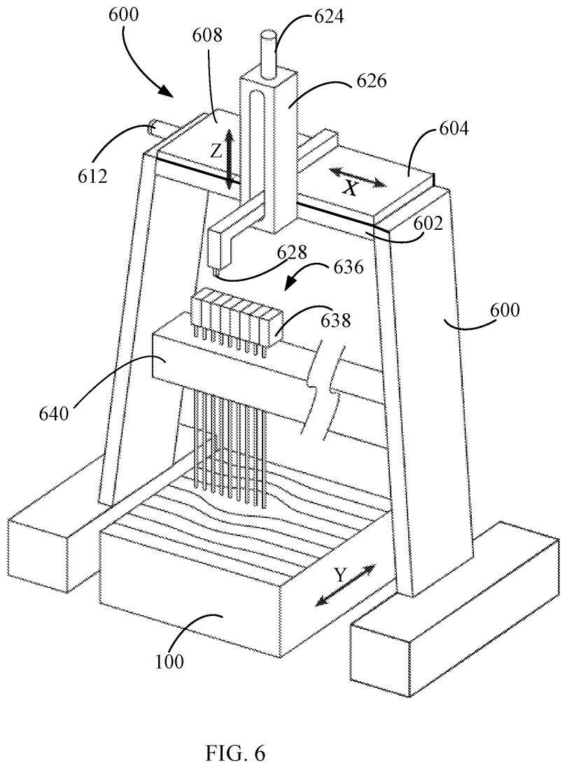

The tension force in the top cable 228 is always higher than the tension force in the bottom cable 244 for each one of the matrix pins 104. The difference in the value of these forces generates a force that moves each matrix pin 104 separately upwards in the calibration station (FIG. 6). In the calibration process, the pin motion is stopped by the free pin locker, canceling any clearance between these pins.

As indicated above, the free pin locking is the only security mean for the calibration locations. The current already calibrated line of pins is locked before the free pins line is shifted to calibrate a new line of matrix pins. The locking will cancel the pin motion ability. The matrix simulates a standard, non-digital mold without the matrix pin motion. A common pin locker is used for this purpose (individual pin locking is not required).

The best cable locking is by clipping both groups of cables—the top cable group and the bottom cable group simultaneously. The locking mechanism act to avoid cable motion (due to the clipping) as this might change the already calibrated positions of the pins.

Thus, before the line of free pins is passing to calibrate a new line of matrix pins, the current already calibrated line of matrix pins is locked. As the entire line is supported by a full line of locked free pins, a common locker is sufficient; there is no need for individual per pin locking.

The cable locking is by clipping both groups of cables—the top cable group and the bottom cable group simultaneously. The cable locking mechanism is configured to avoid any clipped cable/s motion. Cables motion might change the already calibrated positions of the pins.

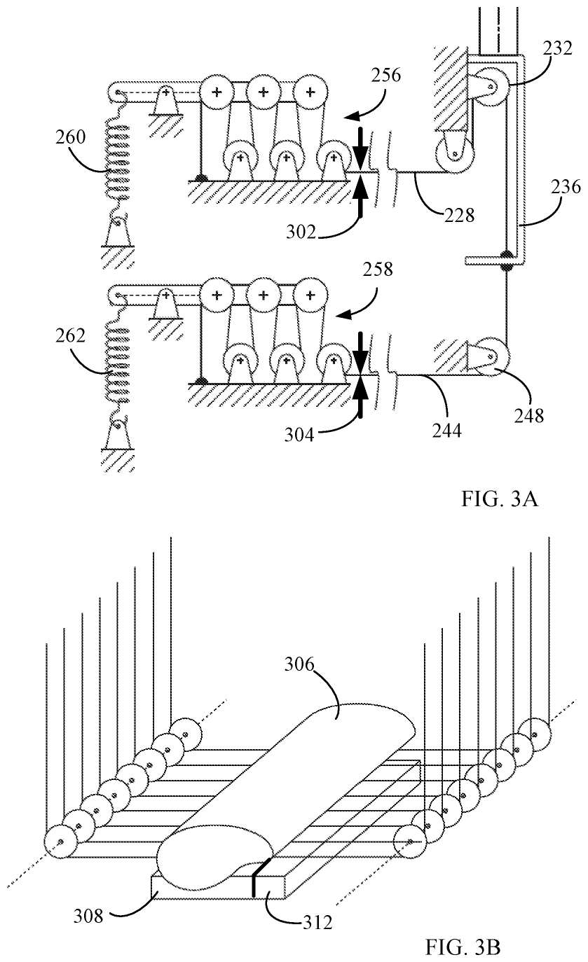

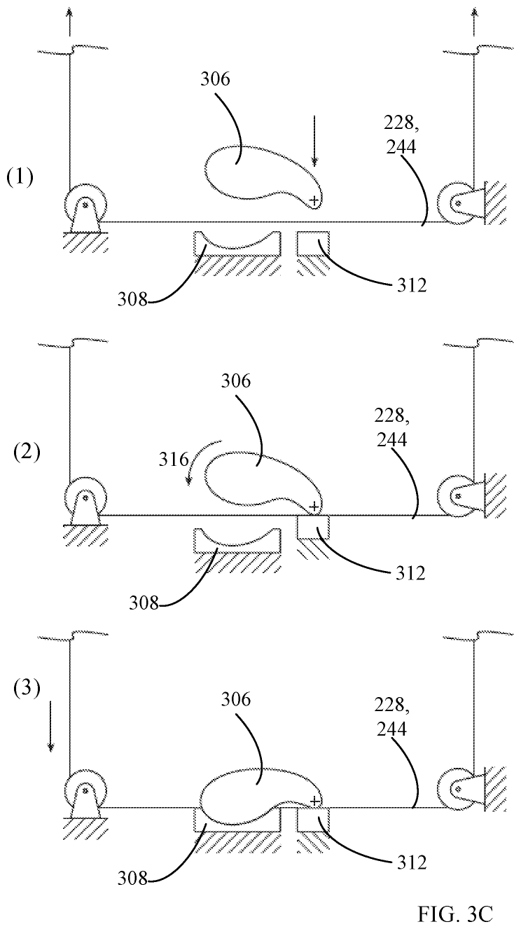

FIG. 3A is an example of a mechanism for locking lines of matrix pins. The figure indicates the clipping/locking points 302 and 304 for both top and bottom cables 228 and 244. These points are external to digital mold matrix volume and close to the relevant stroke amplifier line.

FIG. 3B is an example of the matrix pin locking mechanism. The matrix pin locking mechanism includes a top convex shoe 306 made of soft and high friction material, a concave bottom seat 308 made of hard material, and an anvil 312.

FIG. 3C illustrates the kinematics of a matrix pin locking process. In state (1) the cable/s 228 or 244 passes free through the matrix pin locking module: top convex shoe 306 and concave bottom seat 308, close to anvil 312, without touching them. In-state (2)—the circular edge of the convex shoe 306 is pressing the cable 228 or 244 to anvil 312. The displacement of the cable is very short, and no change in the position of the matrix pin 104 occurs. The pressure applied to the cables 228 and 244 (FIG. 3) and to their anvils 312 could be applied simultaneously for both cables 228 and 244. To press the cable/s to the anvil 312, the convex shoe 306 rotates in the direction indicated by arrow 316. The rolling motion of the convex shoe 306 on anvil 312 enhances the contact between the cables 228 and 244 and the anvil 312 and eliminates locking release. In state (3)—the convex part of the shoe 306 presses the cable to the concave segment of shoe 308. The current disclosure illustrates anvil 312 located at the matrix pin 312 side and the convex shoe 306 with the concave bottom seat 308 at the stroke amplifier (258 and 360256) side. Such arrangement supports the supply of residual cable length required to fill the convex shoe 306 and concave seat 420308 by slightly stretching the stroke amplifier spring. The locking itself is not dependent on the number of pins that are locked/used in the locked line.

According to the pre-programmed operation, the calibrated matrix pins form a virtual plane which is insufficient for fabric layering. The layering process requires a real surface to rest and fix the fabric.

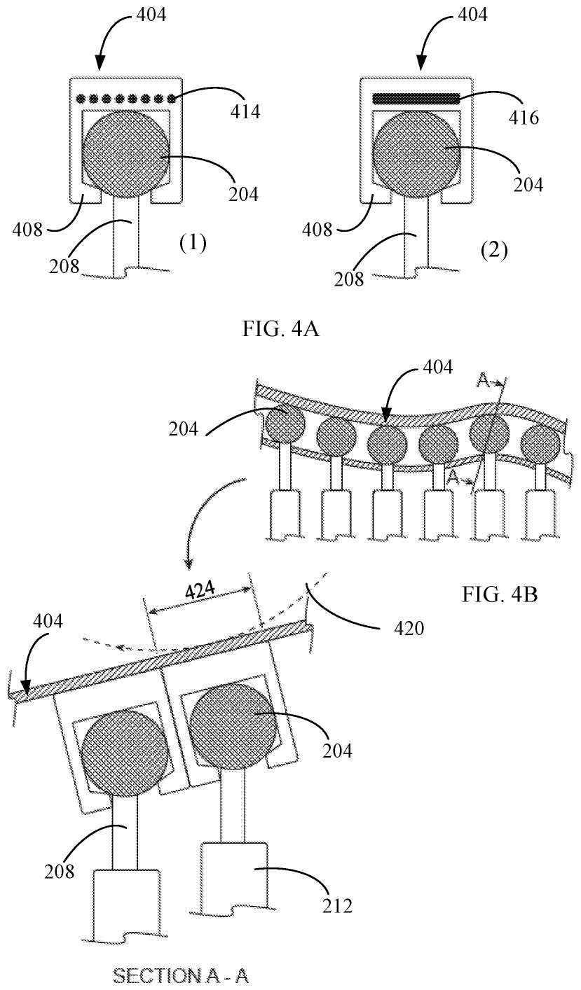

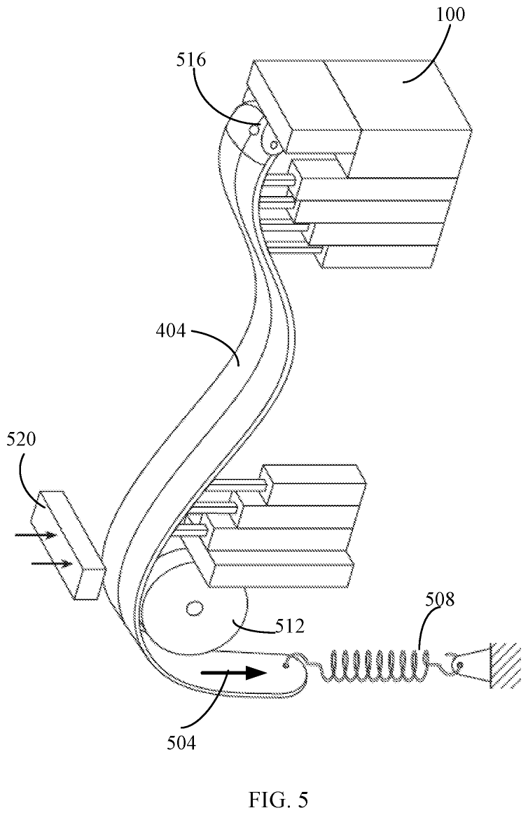

FIG. 4A is a flexible elastomeric strip cross-section suitable for the digital matrix layering surface, particularly curved surface. Such a curved surface is a real surface and could be generated by using flexible strips and placing the strips on ball-terminated edges 204 of the matrix pins 104.

FIG. 4A-1) is an example of a cross-section of elastomeric strip 404. Elastomeric strip 404 forming a real surface rests on a matrix pin ball-shaped or terminated edge 204. The strip includes openings configured to accommodate the cylindrical neck 208. Each strip 404 includes a flexible elastomeric body 408, a stiffening member 414 made of unidirectional fabric, and a groove that supports sliding and tilting on the ball-shaped edge of matrix pins 204.

FIG. 4A-(2) is an example of a cross-section of elastomeric strip 404, similar to the presented in FIG. 4A-(1) with a steel strip 416 instead of the unidirectional fabric 414. The stiffeners reduce or even eliminate stretching of flexible elastomeric body 408 and a groove that supports sliding and tilting on the ball-shaped edge of matrix pins 104. The encapsulated unidirectional fabric 414 or the steel strip 416 does not prevent the elastomeric strip 404 from bending or sliding on the matrix pin ball-shaped edge 204. The steel strip 416 does not prevent elastomeric strip tilt and twist.

FIG. 4B illustrates how the flexible elastomeric strip 404 is mounted on a group or line of matrix pins 104. Cross-section A-A in FIG. 4B demonstrates the usefulness of tilting around the ball-shaped edge 204 of the matrix pin 104 (FIG. 2) and twisting the elastomeric strip 404. The radius R of the pressure applying roller 420 (a part of the fabric layering unit that is not described here) must be sufficiently large. Thus the pressed nip will be larger than the strip 404 widths to allow the presented inclination.

The length of the elastomeric strip 404 is variable and dependents on the virtual line that it should represent. Discrete positions of the matrix pins in the specific digital mold or digital matrix line determine the virtual line. The shorter strip length could occur when all the matrix pins 104 have a similar stroke, probably the highest level. The shortest flexible strip 404 length occurs at every beginning of a calibration process. This short length requires pulling off the flexible strip slack, for example, sliding the strip along the line of ball-shaped edges 204 of matrix pins 104.

FIG. 5 is an example of how the flexible elastomeric strip is mounted on a group or line of matrix pins. A force 504 developed by a spring 508 pulls flexible elastomeric strip 404. A guiding wheel 512 facilitates the application of the force (pulling force) provided by spring 508 to flexible elastomeric strip 404. Following the completion of elastomeric strip 404 calibration, a brake 520 applies pressure to flexible strip 404 covering guiding wheel 512. The pressure prevents strip 404 movements. Brake 520 uses a force more significant than the force applied by the spring 508.

A hinge/pin 516 connects the flexible elastomeric strip 404 to the digital mold matrix enclosure 100. Hinge pin 516 connection carries the spring force 504 to matrix enclosure 100, located on the opposite side of wheel 512. Hinge pin 516 also fixes one side of the flexible elastomeric strip 404 to the frame.

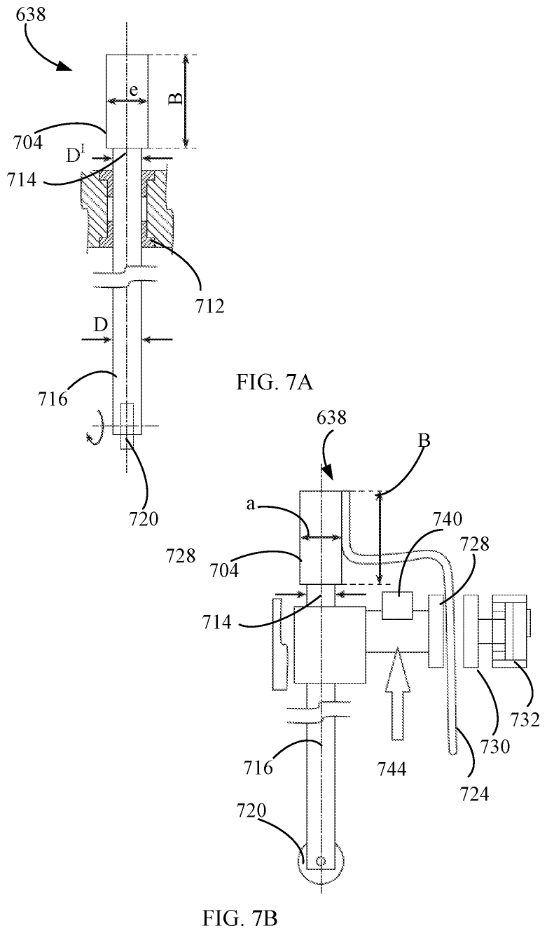

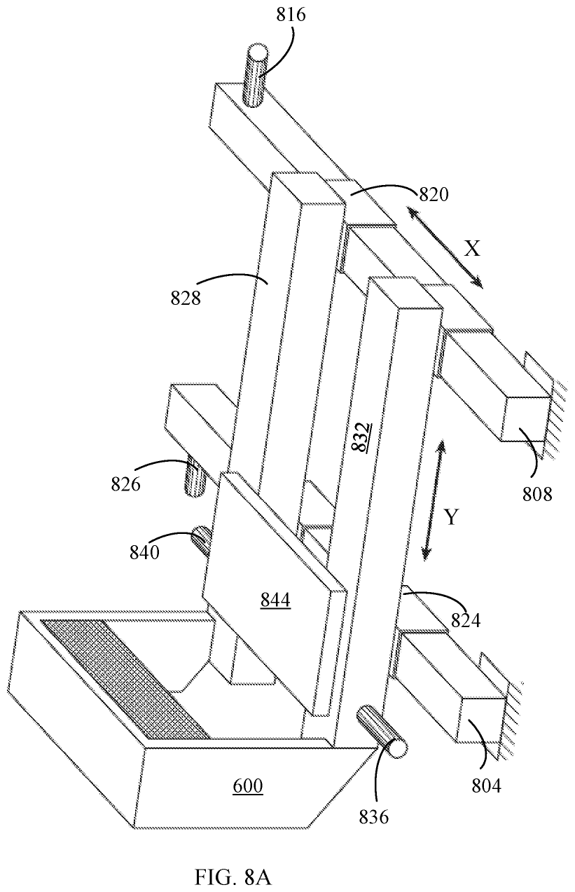

FIG. (6 presents the matrix pin calibration station. The station includes a stationary frame 600 and a bridge 602. A motorized slide 626 is mounted at the top of the bridge 602, and a scanning servomotor 612 is pushing/pulling a carriage 604 that travels along the X-axis direction. An accurate vertical motorized slide 626 is connected to the carriage 604. A pressing servomotor 624 is pushing/pulling a carriage 626 that travels along the Z axis direction. A pushing “finger” 628 having roller 720 (FIG. 7) at its edge is connected to the Z traveling carriage 626. A line of free pins 636 is mounted on a crossbar 640 below the pushing finger 628, allowing the pushing finger to press any free pin 638 when required. Crossbar 640 incorporates the assembly 636 of free pins 638. The matrix pins calibration process starts when the digital mold matrix 100 is brought under the free pins line 636.

The presented assembly includes a single pressing “finger.” However, should the calibration process require expedition, parallel motorized slides (like 626 slides) with additional pushing fingers 628 can be added.

FIG. 7 is an example illustrating the free pin assembly. The crossbar 640 holding the free pins assembly 636 is stationary and connected to the gantry 600 (FIG. 6). Each free pin 638 includes a top square section 704 with “e” side dimension, and “B” length. This square section eliminates the rotation of the free pin. Each free pin 638 includes a cylindrical section 714, with diameter D^{I} that can travel freely in the linear bearing set 712. Each free pin 638 is having a bottom cylindrical section 716 with diameter D, while D>D^{I}. In this way, lifting the pin up will be stopped when the bottom section will reach the linear bearing, and pushing action will be stopped when the upper square section will reach the linear bearings. The direct pressing point of the free pin is via a small roller 720 having a diameter d that is smaller than the system resolution (i.e., the distance between adjacent pins). This mechanism eliminates the need to create complete parallelism between the digital matrix pin line and the calibration unit's free pins.

A braking strip 724 (FIG. 7B) is connected to the square section 704 of the free pin 638. The braking strip 724 slides (with minimal contact) on the static brake shoe 728. When the free pin requires locking (i.e., after calibration of the opposed matrix pin), a linear actuator like pneumatic cylinder 732 is clamping the strip between the static shoe 728 and the dynamic shoe 730 and locks the free pin 638.

A horizontal beam 740 is passing through the free pin line (under the braking strips of all the pins). Both edges of the horizontal beam 740 are connected to two actuators 744 that facilitate lifting the horizontal beam and lift all the free pins in the line-if their lockers are released.

When the calibration process of the entire pin matrix line is finished, all the free pin lockers are released, and the horizontal (lifting) beam lifts the pins to the initial position, the pin lockers are re-engaged, and the calibration process of the next pin matrix line can begin.

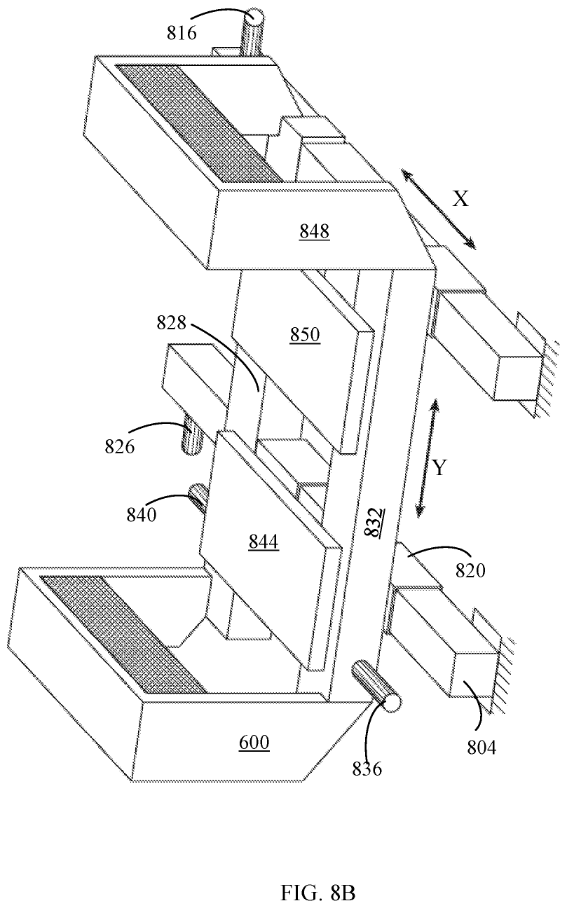

FIG. 8A presents the basic axes X and Y that facilitate the digital mold matrix assembly travel. The elongated X-axis includes two rails 804 and 808 that are anchored to the ground. Two motors 816 and 826 are used for synchronizing the drive of carriages 820 and 824. Two rails of Y-axis 828 and 832 are mounted on these carriages. Two motors, 836 and 840, are used for synchronizing the drive of carriage 844. A calibration unit 600 is installed at the edge of the Y rails and travels with the rails along the X-axis.

FIG. 8B presents a similar configuration to the one of FIG. 8A. It includes an additional calibration unit 848 identical with calibration unit 600 on the opposing side to the unit 600 already presented, and another carriage 850 that travels on Y-axis together with the already presented carriage 844. Each one of the carriages is independent of the other and controlled separately.

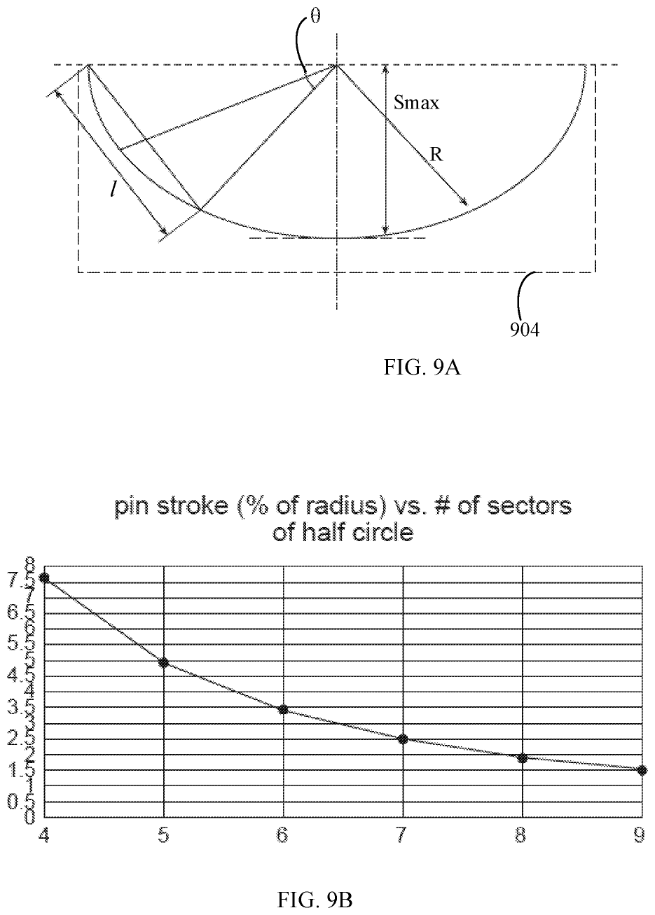

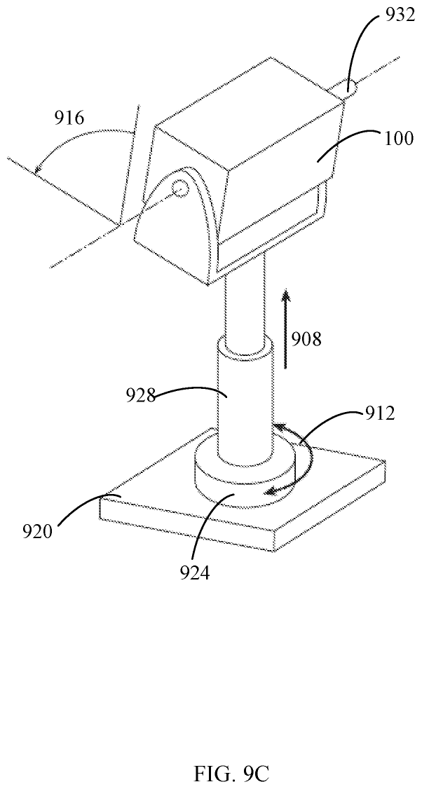

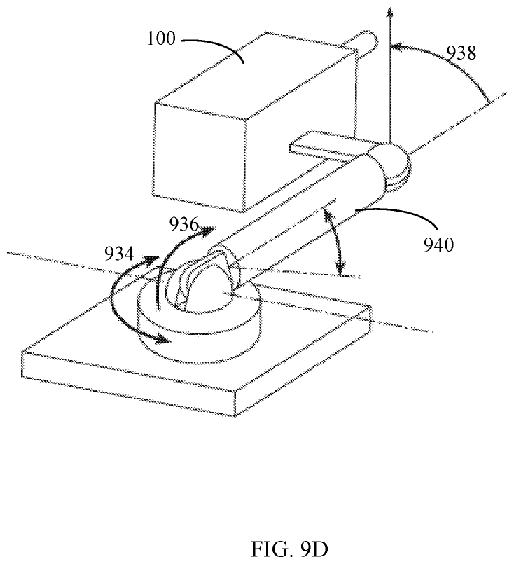

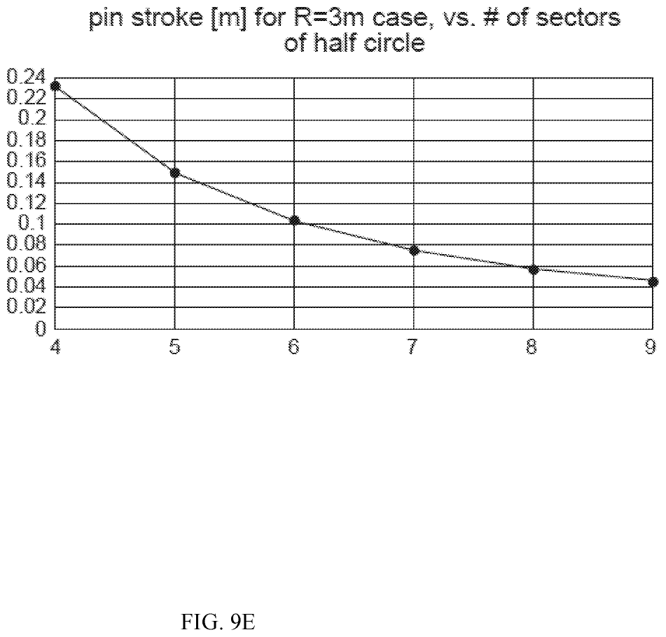

The advantages of using a movable digital mold matrix system, as presented in FIG. 8 are significant when the built parts become large. FIG. 9A demonstrates this aspect: a half of a part with a circular shape, having a radius R. The dashed line presents a single mold position with internal radius of R. If the mold is digital (i.e., pin screen), its maximum pin stroke is S (max)=R. If the mold circumference will be cut to equal sectors (with head angle θ) or tiles, each sector can be represented by a digital matrix unit with the length “l”, and with maximum pin length of “S”. FIG. (9B) presents the pin stroke S vs. the number of sectors (n=number of sectors; θ=180/n). For clarity, this is presented as a non-dimensional value by normalizing it to the circle radius R and presenting it in %. As mentioned above, the stroke equals R when n=1, but the stroke is reduced to 3.5% of R when n=6. This dramatic reduction has a significant impact on the digital matrix cost and feasibility and justifies the complexity related to the use of movable digital matrix unit.

Although in some examples depending on the relation between the digital matrix unit and the 3D object size, the mold circumference could be cut to non-equal sectors or tiles.

FIG. 9B demonstrates the magnitude of this reduction in the case where R=3 m. When n=1, the pin stroke is equal to 3 m. When n=6, the pin stroke is 0.105 m.

The tiles in the digital mold matrix 100 could be properly positioned by moving the digital mold assembly 100 along the three Cartesian axes (X, Y, and Z) and rotating the digital mold around two axes. FIG. 9C is an example of digital mold assembly supporting a linear movement of the digital mold in one movement axis and two angular rotation directions. A simple, three degrees of freedom system holds the digital mold matrix 100, which, as will be explained below, provides the surface that facilitates the curved 3D object manufacture. A base plate 920 connects to the Y-axis carriage 844 or carriage 850 (FIG. 8). Also mounted on the base plate 920 is a rotational motion unit 924 that supports the angular motion of the pin matrix in the direction of arrow 912.

In most cases, the required movement on angle 912 is small, and high rotational speed is not required. A control cylinder 928 mounted on the rotational motion unit 924 provides vertical motion 908 (Z-axis direction) for raising and lowering the digital mold matrix. A tilt mechanism 932, mounted on top of control cylinder 928, supports the digital mold matrix 100 orientation change in the direction of an angle indicated as 916. A motorized unit 932 supports the change in the orientation of the digital mold matrix 100 assembled on top of cylinder 928.

FIG. 9D is an example of digital mold assembly supporting the movement of the digital mold in three angular rotation directions, using a standard robotic arm. The use of a robotic arm 940 supports the same functionality as the system of FIG. 9C and facilitates the use of spherical coordinates.

The use of multiple positions of the digital matrix unit as presented in FIG. 9A, increases the efficiency of the digital matrix. On the other hand—when n=1—a single mold is used. This single mold covers the entire product width. In this case—product tiling is required in the X direction solely as the width of the tile is the width of the product. In the case of n=2 and more, the fabric layering on the digital mold matrix should be performed by tiling in two axes, firstly in the Y-axis direction, to complete a full width of the product (and to reach the n=1 conditions), and then in the X-direction.

FIG. 9E illustrates the length of the matrix pin stroke of the digital mold matrix compared to a matrix pin stroke required for a circle with a radius of three meters.

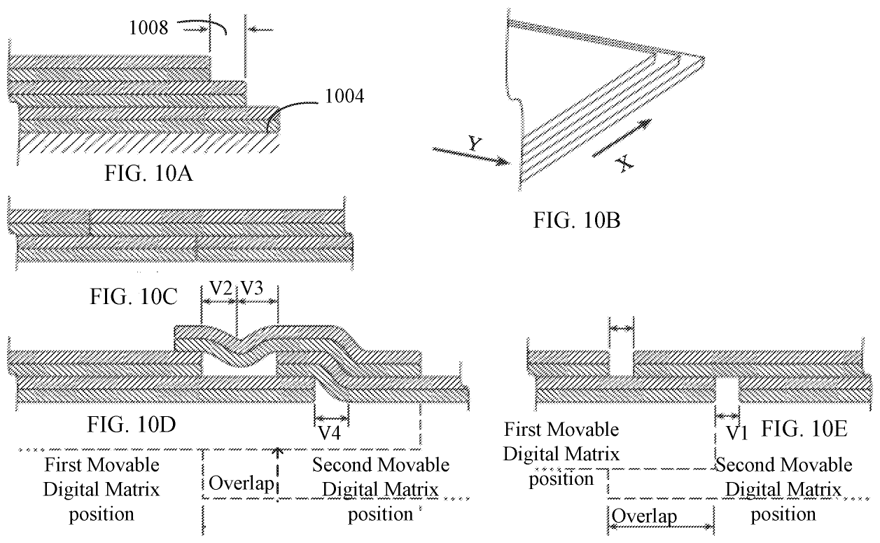

FIG. 10(a) presents the typical prepreg layup by tiling, to facilitate overlapping between adjacent tiles that supports a large part manufacture. Initially, a prepreg layup mechanism is provided. The layup mechanism could include a pressing roller and a UV or heat source. The pressing roller irons the deposited tile to the digital mold surface and squeezes out air that could be trapped between the tile and the digital mold surface. FIG. 10(a) presents the edge of a “tile”-a specific digital matrix station. Each one of the layering actions is by warp and woof 1104. The first pair of layers is layered on the entire DM surface, which could be a curved surface. The next pair is shifted backward in “1008” value which is a constant portion of the DM length. This shift backward is performed for all the coming pairs. The backward shift is performed in two axes, as presented in FIG. 10(b) to facilitate tiling in both Y and X directions. The successive tile layering will at least partially overlap the pairs, as demonstrated in FIG. 10C. This presents an optimal situation where the accuracy of the layering is high.

The tiling errors exist due to the fabric misplacement by the automatic fabric placement unit. FIG. 10 (d presents a case of over-tiling, where the new layering is covering the previous tile, causing voids with the typical length of V2; V4; V4. FIG. 10(e) presents a case of under-tiling, where the new layering generates a gap from the previous tile, causing voids with the typical length of V1. While the case of FIG. 10(d) should be avoided, the case of FIG. 10(e) can be accepted if the volume of void V1 can be filled by the excessive resin filling of the fabric.

FIGS. 10(d) and 10(e) demonstrate the overlap in the adjacent digital matrix positions that facilitate the described layering. As the backward shift 1008 increases and the number of paired layers increases, the overlap magnitude increases, and the entire building process efficiency is reduced. If n=5 (5 position sectors) and the overlap grows to 20%, the real number of required sectors is 6.

The movable digital matrix supports the generation of an external frame connected to the manufactured part, sometimes called “side frame”. In many cases, additional layering on top of the manufactured part is required. The purpose of the additional layering is to increase the stiffness and the bending modulus, and the application of the additional layering requires side frame building. The layering could include non-fabric-based materials (like honeycomb).

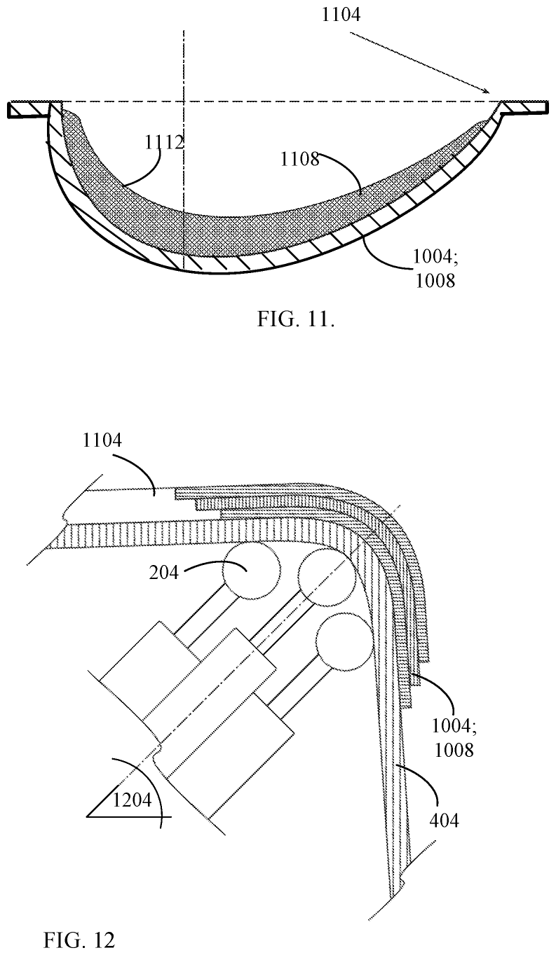

FIG. 11 presents the side frame building, external of the required part envelope. This side frame is used for additional applications that are serial to the disclosed building process and optional. These optional additional processes are honeycomb layering 1114 and balsa-wood 1116 layering. Both are applied using vacuum bag application. The side frame 1104 facilitates vacuum bag application. Additional layer/s of woven fabric-based composite could follow. The additional layers and the structure could be manufactured externally to the described manufacturing system, while the manufactured part is used as a mold (if it is supported properly) and by known applications like vacuum bag process. The frame 1104 also facilitates the vacuum bag process since it could hold the bag and support the manufactured part properly.

The side frame manufacturing requires as close to 90 degrees angle by the mold as illustrated in FIG. 12. Standard pin screen molds, like in the disclosed references cannot support these conditions. It is extremely difficult to bend even the flexible parts disclosed there in 90 degrees using vertically oriented pins solely. FIG. 12 shows how the digital mold can support side frame 1104 manufacturing. As mentioned, stationary pin-screen, or n=1 type pinscreen, does not support close to 90 degrees corners. A typical external side frame requires this shape. The ability to tilt the digital matrix in 1204 angle allows the positioning of the pin matrix in the angle presented in FIG. 12, and the close to sharp corner generation. The woven fabric that is layered on the flexible strip 404 (FIG. 4) can be overlapped to perform the manufactured part and a frame 1104.

The part building process, i.e., woven fabric layering and pressing, begins in the first prepreg tile layering. The prepreg tiles could be earlier prepared or purchased from a third party. The digital mold matrix surface could be supported by the digital mold matrix surface that could be a curved surface.

The next tile (Y-axis wise) building will require the following steps:
extraction of the current tile from the digital matrix;
bringing another digital matrix calibrated to the new position, or calibrating the current digital matrix to the new configuration;
moving the digital matrix to the new position that overlaps the previous tile;
attaching the previous tile to the new position of the digital matrix;
beginning to build the current tile.

The described process could leave the previously deposited tile not supported since it removes the digital matrix support, moving it to the location for the new tile production. Because of the digital matrix support, move the previously built tile needs to be supported externally.

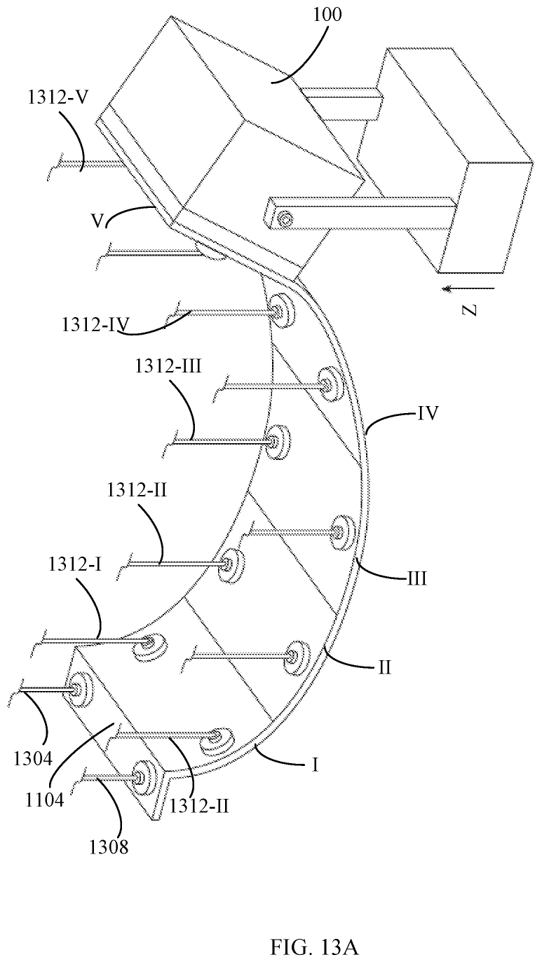

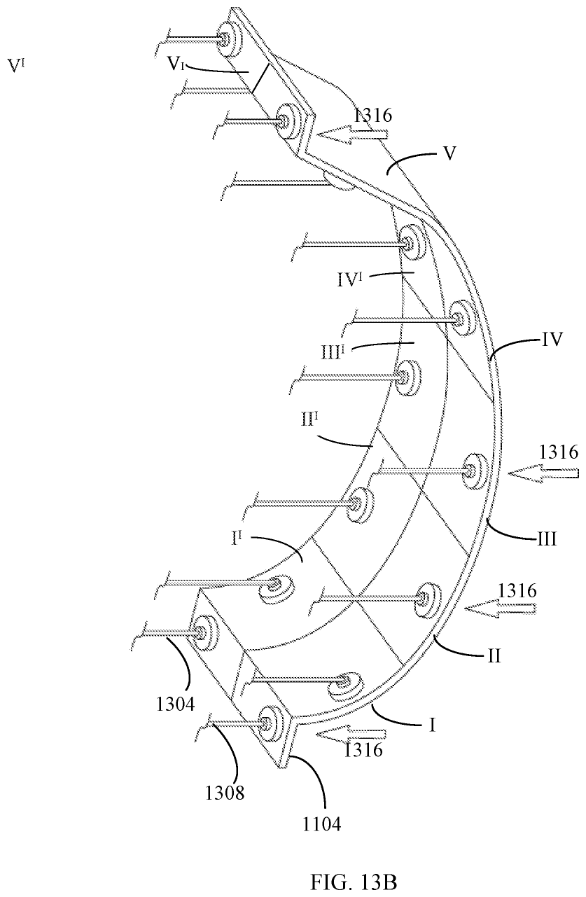

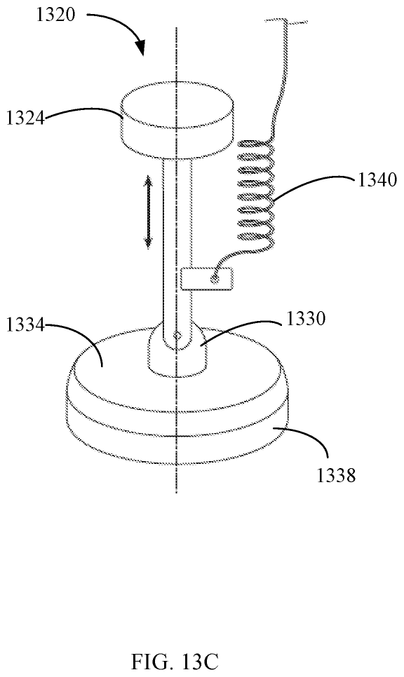

FIG. 13A is a schematic illustration of the process of building the first line of the product. Two vacuum anchoring units, a front anchoring unit 1312-1 and a rear anchoring unit 1312-2, support a previously built frame 1104. Additional anchoring units 1312-I, 1312-II, 1312-III, 1312-IV, and 1312-V support each of the five following tiles: I; II; III; IV; V. Tile I is supported by the frame fabric overlapping, by the front unit 1312-1 and by the rear unit 1312-II, i.e., tile I is supported from all sides, allowing disconnection of the digital matrix. In the figure, tile V state is “in building process” and thus the digital matrix assembly 100 supports it.

The extraction of the digital matrix from the built part (the first step of next tile production process) is assisted by pressurizing the digital matrix enclosure 100 (FIG. 1). The high flow of air is flowing through the opening between the flexible strips. Due to the large area of the digital matrix, even relatively low-pressure values (generated by the airflow) produce high extraction forces that support easy tile extraction from the digital matrix.

When the digital matrix reaches its new location, the reaction for the engagement force acting between the digital matrix and the overlapped area of the previous tile is provided by the top anchoring units of the previous tile. The distance between the front and rear anchoring units might be significant so that the tile surface attachment might be insufficient. To overcome this, the high flow/low vacuum aspirator 120 (FIG. 1) could apply low pressure to ensure surface attachment.

The aspirator continues to work and maintains the low-pressure high-flow vacuum flow throughout the manufacturing process. The vacuum could assist in maintaining a good attachment of the built tile to the digital matrix, especially when the direction of build part is close to vertical (low 1204 angle), when the contribution of the gravitation to the attachment is low.

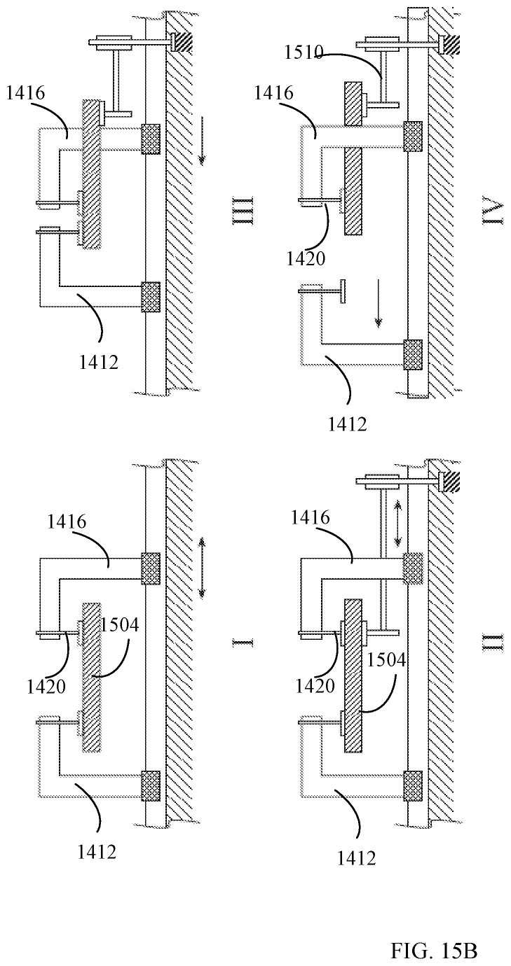

FIG. 13B illustrates the support of the built tiles from the second and higher order lines of tiles. The newly built line could, for example, include five tiles—I^{I}; II^{I}; III^{I}; IV^{I}; and V^{I}. The newly laid tiles require the support of a front anchoring unit 1312-2 solely. The rear anchoring unit becomes the front anchoring unit of the previously built line. This “stepping forward” process of the top anchoring units will be described below. The open edge stiffness is sufficient in most cases, and less dense bottom support 1316 can be applied. A detailed presentation of the bottom support is described below (FIG. 15B).

FIG. 13C is an example of a vacuum anchoring unit. Vacuum anchoring unit 1320 includes a vertical operator, for example, a pneumatic cylinder 1324. Closure of inlet/outlet ports of vertical operator 1324 locks the vertical operator position. A universal joint 1330 connects vertical operator 8301324 to a vacuum holder or cup 1334 via a universal joint 1330. The universal joint is lockable per command. Vacuum holder 1334 contains a soft rubber suction cup 1338. A vacuum generator (not shown) operated by compressed air via compressed air hose 1340 generates the vacuum.

The described above configuration allows to “drop” the vacuum holder (by the vertical operator) downwards until the built tile stops the holder. The vacuum generator is operated, and the holder tilts itself to align with the tile surface. The position accuracy and stiffness of the anchoring units are not especially demanding as the overlapping area defines the final position with the digital matrix in its new location.

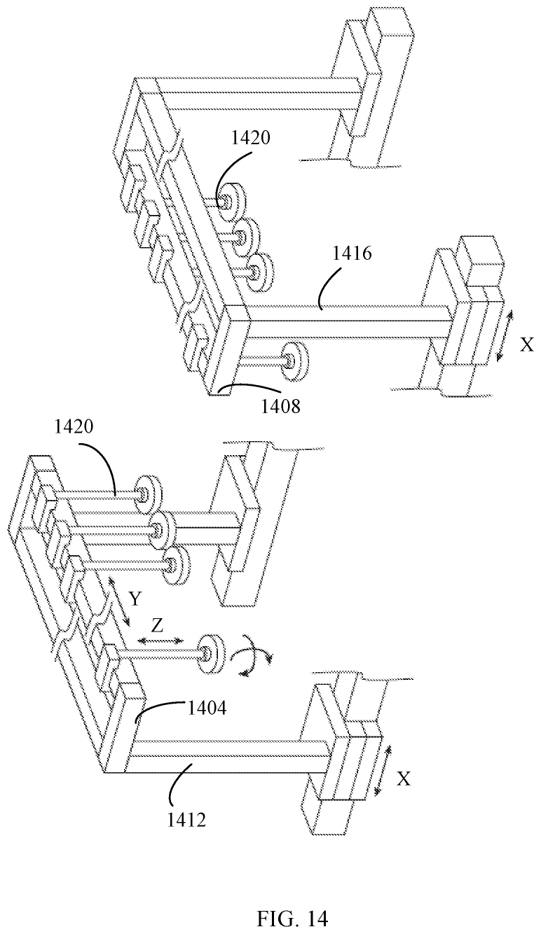

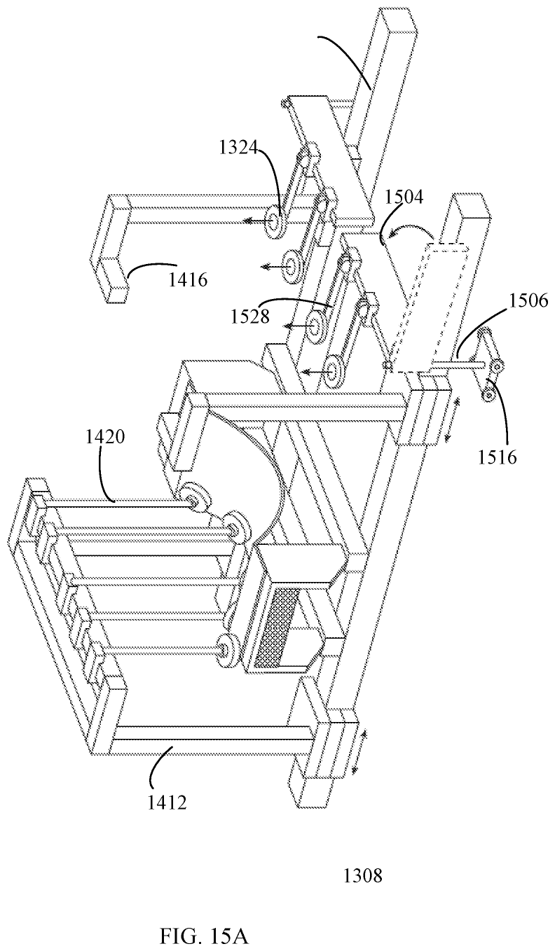

FIG. 14 is a schematic illustration of the two bridges that carry the vacuum anchoring units and are traveling on X rails. Cantilever arms 1404 and 1408 serve as mounts for the front bridge 1412, and the rear bridge 1416 hanged on the cantilever arm are vacuum anchoring units 1420. The vacuum units are traveling separately in Y and Z directions.

Both bridges are self-motorized and could travel independently of each other on the X rails, together with the building platform (FIG. 15). The vacuum anchoring units of both bridges are motorized and can travel independently of each other along the Y-axis. The vacuum anchoring units could locate themselves on the line according to the stages of the building process. The number of anchoring units in each bridge is dependent on the number of tiles per line. For example, building N tiles per line requires N+2 anchoring units per bridge.

FIG. 15A illustrates additional details of bottom support 1324 of FIG. 13. FIG. 15A shows the manufacturing system completed the first tile line production. The front and the rear bridges 1412 and 1416 hold the anchoring units 1420 on both sides of the tile line. According to FIG. 13B, the building of the next tile line, could start by disengaging the front bridge, and making it free to support the front edges of the next tile line. The rear bridge could reach the location that was left by the front bridge, and bottom support should enter and support the free edge.

Two platforms provide the bottom support, 1504 folded out of the X travel path. Each platform is mounted on a vertical hinge 1506 to allow folding into the apparatus as presented in the drawing. Each platform is mounted on a heavy base 1516 equipped with wheels. Each platform is equipped with vacuum holders 1324. Each vacuum holder is connected to a lifting arm 1528. In this platform condition, the vacuum holders could engage the free edge of the tile line. The bottom support 1316 (FIG. 13) of the free edge is provided while operating the vacuum generator that is mounted on the holder.

The next step in the manufacturing process (after the first line production completion, as presented in FIG. 15A is the next tile line production. This next step requires to step forward the front and rear bridges 1412 and 1416 (FIG. 14). FIG. 15B is a schematic description of the “stepping forward” process, using the top anchoring units and the bottom support.

Step (I) presents the starting point. Two lines of vacuum anchoring units front 1312 and rear 1312 mounted on the front 1412 and rear 1416 bridges hold the built tile line 1504.

Step (II) illustrates the engagement of the bottom support using the vacuum holders and the lifting arm 1528.

Step (III) illustrates the disengagement of the rear bridge anchoring units 1412 and 1416 and moves the bridge forward, as close as possible to the front bridge anchoring units 1416 location.

Step (IV) shows the disengagement of the front bridge and relocation to the position that facilitates the building of the next line.

Step (IV) indicates that a bridge top anchoring support, together with the bottom support 1510 are sufficient support. This indicates also that a bottom support 1510 is not required every tile line, but only when:

The weight of the product is too heavy for full-line support of the vacuum anchoring units.

The deflection (of the built part) because of the supported length and to self-weight is too high.

The bottom support platforms can be used to remove the product from the building system.

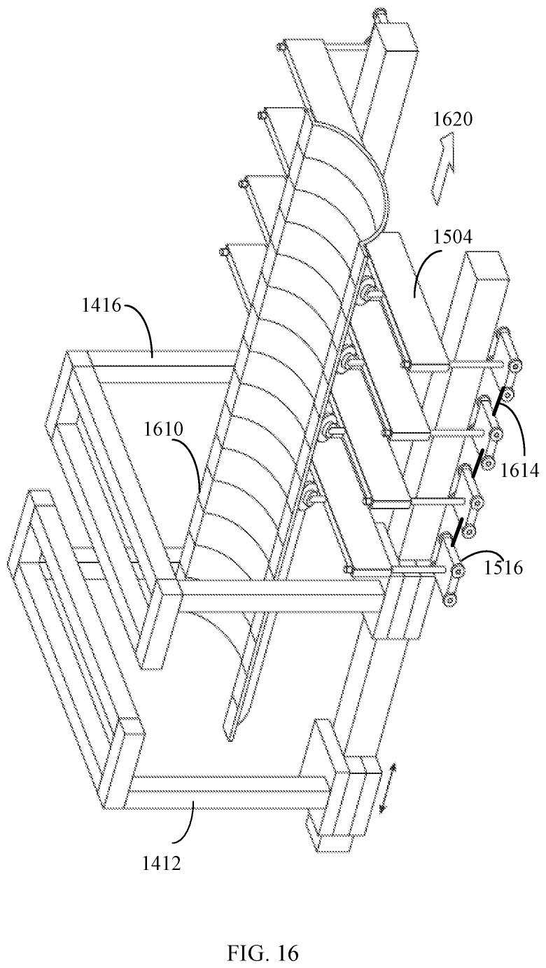

The bottom support platform assists in removing the finished product (3D object) from the described building system. FIG. 16 is an example of four platforms 1516 (FIG. 15) that support the half-cylinder elongated product 1610. Due to the weight balance, the free edge close to the rear and front bridges 1416 and 1412 can be disengaged from the top hanging by the anchoring units' lines. After disengagement, the final product 1610 is fully supported by the platforms 1504. Connecting the platforms bases by connecting rods 1614 and locking them facilitates removing the product from the building system in the direction of the arrow 1620 using the platforms 1516 bases wheels. This facilitates new product building by the system and the current product finishing in a different location.

It will be appreciated by persons skilled in the art that the present disclosure is not limited to what has been particularly shown and described hereinabove. Rather, the scope of the method and apparatus includes both combinations and sub-combinations of various features described hereinabove and modifications and variations thereof which would occur to a person skilled in the art upon reading the foregoing description and which are not in the prior art.

1. A configurable mold for manufacture of 3D objects from woven fabric composite materials, comprising:
an enclosure with a matrix of movable passive individual pins configured to form a curved surface adapted to receive a layup of a woven fabric composite materials;
a mechanism configured to assemble a flexible elastomeric strip on ballshaped edges of a matrix of movable passive pins of a configurable mold matrix;
a mechanism configured to lock in place movable pins that formed a curved surface; and
wherein a flexible elastomeric strip resting on the ball-shaped edges of movable passive matrix pins supports a generation of a uniform curved surface from a discrete presentation by ball-shaped edges of a matrix of movable pins; and wherein the matrix pins activations and internal position measurement sensors are located outside to enclosure.

2. The configurable mold of claim 1, wherein the configurable mold further includes at least a pair of stroke amplifiers and a pair of tension cables associated with each individual movable pin; and wherein at least the pair of stroke amplifiers and the pair of tension cables are external to the enclosure.

3. The configurable mold of claim 2, wherein location of the pairs of stroke amplifiers and the multiple pairs of tension cables external to the enclosure supports high-density packaging of matrix pins.

4. The configurable mold of claim 2, wherein a difference in tension force between the pair of tensioning cables generates a force that moves each movable matrix pm to a predetermined direction.

5. The configurable mold of claim 1, wherein the mechanism configured to lock in place the movable pins that formed a curved surface, comprises: a top convex shoe made of soft and high friction material: a concave bottom seat made of hard material; and an anvil.

6. The configurable mold of claim 5, wherein the top convex shoe includes a circular edge pressing cables to the anvil and preventing their displacement.

7. The configurable mold of claim 1, wherein each movable individual pm includes a ball-shaped edge, a cylindrical neck, and a body with a rectangular cross-section.

8. The configurable mold of claim 7, wherein a flexible elastomeric strip supports the generation of a uniform curved surface from the discrete surface presentation by the matrix pins.

9. The configurable mold of claim 1, wherein the enclosure with a matrix of movable individual pins also includes a connection to a high pass pressure valve and a high flow vacuum valve.

10. A method for the manufacture of large, curved 3D objects, comprising: providing a configurable support surface configured to receive and support a large curved woven fabric composite material object; dividing large curved woven fabric composite material object into individual tiles; employing a matrix mold unit for depositing at least one tile of a large curved woven fabric based composite material object; and repositioning a matrix mold unit and depositing at least one next tile.

11. The method of claim 10, wherein repositioning the matrix mold unit along at least three Cartesian axes and providing a rotational movement around two axes.

12. The method of claim 11, wherein repositioning the matrix mold unit by shifting the matrix mold unit backward on a value that is a constant portion of a digital matrix unit length.

13. The method of claim 10, wherein a newly deposited next tile at least partially overlaps an earlier deposited tile.

14. The method of claim 10, wherein the individual tiles are one of a group of tiles consisting of equal size tiles and non-equal size tiles.

15. An apparatus for the manufacture of 3D objects from woven fabric based composite materials, comprising:
a configurable support surface configured to receive and support woven fabric based composite materials;
a mechanism configured to move the support surface along at least three Cartesian axes and provide a rotational movement around two axes;
at least one calibration unit operative to set a desired shape of the configurable support surface.

16. The apparatus of claim 15, wherein a matrix of movable and adjustable pins forms the configurable support surface and wherein the movable and adjustable pins are passive.

17. The apparatus of claim 15, wherein the calibration unit includes a linear matrix of movable and adjustable pins mounted on a crossbar.

18. The apparatus of claim 15, wherein an enclosure includes at least a line of movable matrix pins and wherein the enclosure provides guides for each line of movable matrix pins.

19.-58. (canceled)
